(19) United States
(12) Patent Application Publication
(10) Pub. No.: US 2026/0154422 A1
(43) Pub. Date: Jun. 4, 2026

(54) AUTONOMOUS AGENTIC AI DEFENSE FRAMEWORK FOR CRITICAL INFRASTRUCTURE

(71) Applicant: Nilesh Dnyaneshwar BHAND, Redmond, WA (US)

(72) Inventor: Nilesh Dnyaneshwar BHAND, Redmond, WA (US)

(21) Appl. No.: 19/457,330

(22) Filed: Jan. 23, 2026

(51) Int. Cl. G06F 21/57

(52) U.S. Cl. CPC G06F 21/577; G06F 2221/034

(57) ABSTRACT

The present invention relates to an autonomous agentic artificial intelligence based defense system for protecting critical infrastructure from cyber threats through continuous, validated, and adaptive security operations. The system employs distributed processing units configured to analyze operational telemetry, network communication data, and control signals in real time to identify deviations from established infrastructure behavior. Artificial intelligence based characterization logic is applied to correlate detected deviations with stored threat profiles and infrastructure parameters, followed by multi-stage validation to confirm threat authenticity and severity. Adaptive learning mechanisms dynamically update characterization thresholds and validation parameters based on historical incidents and evolving attack patterns, enabling continuous improvement without manual reconfiguration.

### TECHNICAL FIELD OF THE INVENTION

The present invention relates to the field of cybersecurity and infrastructure protection, and more particularly to an autonomous agentic artificial intelligence based defense system implemented as a physical and logical machine structure for continuous monitoring, threat characterization, validation, and response orchestration in critical infrastructure environments including power grids, industrial control systems, water treatment facilities, transportation networks, and communication backbones.

### BACKGROUND OF THE INVENTION

Critical infrastructure systems form the backbone of modern societies and are increasingly dependent on interconnected digital control architectures, networked sensors, and automated operational workflows. While digitization has significantly improved efficiency and scalability, it has simultaneously expanded the attack surface available to sophisticated cyber adversaries. Existing cybersecurity solutions deployed in such environments primarily rely on static rule-based intrusion detection systems, signature matching firewalls, or centralized monitoring platforms, which are fundamentally limited in their ability to adapt to evolving multi-stage, polymorphic, and coordinated cyber threats. These traditional approaches often operate in isolation, lack contextual awareness of infrastructure-specific operational states, and fail to correlate distributed threat signals across heterogeneous subsystems.

Conventional security architectures are further constrained by their dependence on human-in-the-loop intervention for incident validation and response execution, resulting in delayed mitigation actions and increased exposure windows. Many current solutions are unable to distinguish between legitimate operational anomalies and malicious activities, leading to false positives that disrupt infrastructure continuity or false negatives that allow persistent threats to remain undetected. Moreover, existing systems generally lack autonomous learning capabilities, making them ineffective against zero-day attacks, advanced persistent threats, and coordinated attack campaigns that exploit temporal, spatial, and behavioral correlations across infrastructure layers.

Another major limitation of prior art systems lies in their centralized processing models, which create single points of failure and scalability bottlenecks. Such architectures struggle to process high-volume telemetry streams generated by distributed infrastructure components in real time. Additionally, the absence of autonomous validation mechanisms results in limited confidence in threat attribution and response justification, undermining trust in automated defense actions. As critical infrastructure environments demand high availability, deterministic response behavior, and minimal operational disruption, there exists a clear need for a defense system that can autonomously reason, validate, and act with infrastructure-aware intelligence.

Accordingly, there is a long-felt need for an advanced defense system that combines distributed artificial intelligence agents, autonomous decision-making, continuous learning, and infrastructure-integrated validation within a unified machine architecture capable of providing resilient, adaptive, and explainable protection for critical infrastructure systems.

The protection of critical infrastructure has become an increasingly complex challenge due to the rapid digitization of operational technologies and the convergence of information technology networks with industrial control systems. Power generation and distribution systems, water treatment plants, transportation control networks, oil and gas pipelines, healthcare infrastructure, and communication backbones now rely heavily on interconnected sensors, programmable logic controllers, supervisory control and data acquisition systems, and cloud-assisted analytics for real-time operation and optimization. While this digital transformation has improved efficiency, scalability, and remote operability, it has also exposed critical infrastructure to a wide spectrum of cyber threats that were previously nonexistent or isolated. The increasing sophistication of cyber attacks targeting such systems has revealed fundamental weaknesses in traditional cybersecurity solutions, particularly in their ability to understand, adapt to, and autonomously respond to evolving threat landscapes.

Existing cybersecurity solutions for critical infrastructure are predominantly based on perimeter defense mechanisms such as firewalls, intrusion detection systems, intrusion prevention systems, and signature-based malware detection tools. These solutions primarily rely on predefined rules, static signatures, or known attack patterns to identify malicious activity. While effective against previously cataloged threats, such approaches are inherently reactive and fail to provide adequate protection against zero-day attacks, polymorphic malware, and advanced persistent threats that dynamically alter their behavior to evade detection. Moreover, signature-based systems require frequent manual updates and centralized management, making them slow to adapt in highly dynamic infrastructure environments where new devices, protocols, and configurations are continuously introduced.

Another limitation of existing solutions lies in their centralized architecture. Many security monitoring platforms aggregate data from distributed infrastructure components into a central processing unit or security operations center for analysis. This centralized model creates significant latency in threat detection and response, particularly when large volumes of telemetry data must be transmitted, processed, and correlated in real time. In critical infrastructure contexts, even minor delays in response can result in cascading failures, physical damage, or safety hazards. Centralized architectures also introduce single points of failure, where the compromise or overload of the central analysis component can degrade or completely disable the security posture of the entire infrastructure.

Conventional cybersecurity systems also exhibit limited contextual awareness of infrastructure-specific operational states. Industrial environments generate a wide range of anomalies that are not necessarily indicative of cyber attacks, such as fluctuations due to maintenance activities, load variations, or sensor calibration events. Existing systems often lack the ability to distinguish between benign operational deviations and malicious actions, leading to high false positive rates. These false alarms burden operators, erode trust in automated systems, and in many cases result in security alerts being ignored or disabled, thereby increasing the risk of successful attacks. Conversely, false negatives occur when subtle or slow-moving attacks blend into normal operational noise, remaining undetected for extended periods.

Machine learning-based security solutions have been introduced to address some of these challenges by enabling pattern recognition and anomaly detection beyond static rules. However, many such solutions are implemented as isolated analytical components rather than integrated defense systems. They often operate on limited datasets, lack continuous learning capabilities, and require extensive offline training using curated data that may not reflect real-world attack scenarios. Furthermore, many machine learning models function as black boxes, providing little explanation or validation of their outputs. In critical infrastructure environments, where accountability, safety, and regulatory compliance are paramount, the inability to validate or justify automated decisions significantly limits the adoption of such systems.

Existing solutions also struggle with coordinated and multi-stage attacks that unfold over time and across multiple infrastructure components. Traditional detection mechanisms typically analyze events in isolation, failing to correlate low-level indicators that, when combined, reveal sophisticated attack strategies. Advanced persistent threats often exploit this limitation by distributing their activities across different network segments, devices, and time intervals to avoid triggering detection thresholds. Current systems lack the capability to autonomously reason across distributed observations and collaboratively assess threat progression, resulting in fragmented security visibility and delayed response.

Another major drawback of current cybersecurity frameworks is their heavy reliance on human intervention for threat validation and response execution. Security analysts are often required to manually investigate alerts, determine their legitimacy, and decide on appropriate mitigation actions. This human-in-the-loop model is not scalable in environments where the volume of security events is high and response times must be extremely low. Additionally, human decision-making is susceptible to fatigue, bias, and inconsistency, further reducing the effectiveness of manual validation processes in critical infrastructure contexts.

Energy efficiency and resource constraints present additional challenges for existing security solutions. Many critical infrastructure components operate in environments where computational resources, power availability, and communication bandwidth are limited. Traditional security platforms, designed for enterprise IT environments, are often too resource-intensive to be deployed directly on edge devices or industrial controllers. As a result, security functions are either omitted at the edge or offloaded to centralized systems, exacerbating latency and resilience issues.

Furthermore, existing systems generally lack autonomous adaptation and self-improvement capabilities. Threat landscapes evolve continuously as attackers develop new techniques, tools, and tactics. Current defense mechanisms require periodic manual reconfiguration, rule updates, and model retraining to remain effective. This static or semi-static nature of existing solutions creates windows of vulnerability during which infrastructure remains exposed to newly emerging threats. The absence of continuous learning and autonomous model evolution significantly limits long-term protection effectiveness.

Interoperability is another critical limitation of existing cybersecurity solutions. Critical infrastructure environments are highly heterogeneous, comprising legacy systems, proprietary protocols, vendor-specific devices, and modern digital components. Many security products are designed for specific platforms or protocols and cannot seamlessly integrate across diverse infrastructure layers. This fragmentation results in security silos, inconsistent visibility, and gaps in coverage that attackers can exploit.

Additionally, current solutions provide limited support for post-incident analysis, forensic validation, and compliance documentation. While logs and alerts may be generated, they often lack structured contextual information necessary to reconstruct attack timelines, validate defense actions, or demonstrate regulatory compliance. This deficiency complicates incident response, recovery planning, and continuous improvement efforts.

In view of these limitations, it is evident that existing cybersecurity solutions are insufficient to address the complex, dynamic, and high-stakes nature of critical infrastructure protection. There is a clear technological gap for a defense system that can operate autonomously, reason collaboratively across distributed components, validate threats with infrastructure-aware intelligence, adapt continuously to evolving attack patterns, and execute timely responses without compromising operational continuity. The present invention is conceived to overcome these drawbacks by introducing an autonomous agentic artificial intelligence defense architecture specifically engineered to meet the stringent reliability, adaptability, and safety requirements of critical infrastructure environments.

### SUMMARY OF THE INVENTION

The present invention provides a framework for a multi-agent AI system designed for the autonomous defense of critical infrastructure networks (e.g., power grids, water treatment facilities). This system would consist of specialized AI agents that collaborate to perform proactive threat hunting, real-time anomaly detection, and automated incident response within OT/ICS/SCADA environments. The core innovation lies in the agentic architecture, enabling autonomous decision-making and adaptive defense strategies that can operate at machine speed, far surpassing human capabilities.

The present invention further provides an autonomous agentic AI defense system implemented as a distributed machine architecture comprising multiple cooperative artificial intelligence agents deployed across critical infrastructure layers. The system is configured to continuously ingest operational telemetry, network traffic data, control signals, and environmental parameters, and to autonomously characterize cyber threats through collaborative reasoning, adaptive pattern recognition, and multi-stage validation. Unlike conventional centralized systems, the disclosed invention employs decentralized intelligence embedded within infrastructure nodes, enabling localized detection, rapid response, and global coordination without compromising operational continuity.

The system incorporates adaptive learning mechanisms that refine threat models based on historical attack patterns, infrastructure behavior baselines, and contextual operational states. Autonomous validation units confirm detected threats through cross-agent consensus, temporal consistency checks, and infrastructure-aware rule evaluation, thereby reducing false positives and enhancing response reliability. The invention further integrates energy-efficient processing elements and scalable communication interfaces, allowing long-term deployment in resource-constrained and mission-critical environments.

The principal object of the present invention is to provide an autonomous agentic artificial intelligence based defense system capable of continuously protecting critical infrastructure from cyber threats by performing real-time threat detection, characterization, validation, and response without reliance on static rules or constant human intervention, thereby ensuring high availability, operational continuity, and resilient security enforcement across complex infrastructure environments.

Another object of the invention is to develop a distributed defense architecture comprising multiple cooperative artificial intelligence agents deployed across infrastructure layers, wherein each agent independently analyzes localized operational and security data while collaboratively reasoning with other agents to form a comprehensive and accurate understanding of threat behavior, attack progression, and infrastructure impact, thus overcoming the limitations of centralized and isolated security systems.

A further object of the invention is to enable precise and infrastructure-aware threat characterization by integrating adaptive learning mechanisms, contextual operational modeling, and multi-factor validation techniques that distinguish malicious activities from legitimate operational anomalies, thereby reducing false positives and false negatives and improving confidence in automated security decisions.

Yet another object of the invention is to provide an autonomous validation mechanism that confirms detected threats through cross-agent consensus, temporal correlation, and consistency analysis, ensuring that security responses are justified, explainable, and aligned with infrastructure safety and regulatory requirements before execution.

An additional object of the invention is to implement an intelligent response orchestration capability that determines and executes appropriate mitigation actions based on threat severity, infrastructure criticality, and operational constraints, enabling rapid containment of cyber incidents while minimizing disruption to essential services and physical processes.

Another object of the invention is to incorporate continuous learning and self-optimization capabilities that allow the defense system to evolve over time by assimilating new threat intelligence, learning from past incidents, and adapting detection and validation models to emerging attack techniques without manual reconfiguration.

A further object of the invention is to ensure scalability and interoperability of the defense system across heterogeneous critical infrastructure environments, including legacy systems and modern digital platforms, by supporting diverse protocols, data sources, and deployment configurations while maintaining consistent security coverage and performance.

Yet another object of the invention is to optimize resource utilization and energy efficiency by employing lightweight artificial intelligence models, adaptive workload distribution, and context-aware activation of defense functions, thereby enabling sustained deployment in resource-constrained and mission-critical infrastructure components.

An additional object of the invention is to provide comprehensive security logging, auditability, and forensic support by generating structured, validated, and context-rich security records that facilitate incident investigation, compliance reporting, and continuous improvement of defense strategies.

A further object of the invention is to establish a robust, autonomous, and intelligent defense framework that enhances trust in automated cybersecurity systems for critical infrastructure by combining distributed intelligence, validated decision-making, and adaptive protection mechanisms, thereby significantly improving the overall resilience and security posture of essential infrastructure systems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a system for autonomous agentic artificial intelligence based defense of critical infrastructure; and

FIG. 2 displays a flow chart for a computer-implemented method for autonomous agentic artificial intelligence-based defense of critical infrastructure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

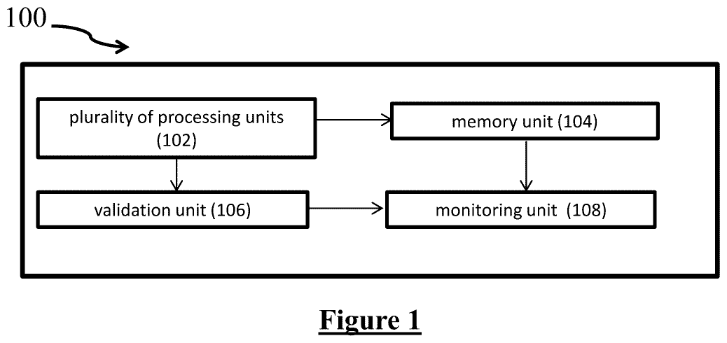

The present invention provides a framework for a multi-agent AI system designed for the autonomous defense of critical infrastructure networks (e.g., power grids, water treatment facilities). This system would consist of specialized AI agents that collaborate to perform proactive threat hunting, real-time anomaly detection, and automated incident response within OT/ICS/SCADA environments. The core innovation lies in the agentic architecture, enabling autonomous decision-making and adaptive defense strategies that can operate at machine speed, far surpassing human capabilities. Referring to FIG. 1, a block diagram of a system for autonomous agentic artificial intelligence based defense of critical infrastructure, wherein the system is configured to characterize cyber threats through multi-agent security validation is illustrated. The system 100 comprises: a plurality of processing units (102) configured to continuously analyze threat signatures, attack relationships, and vulnerability transitions in real time; a memory unit (104) operatively coupled to the plurality of processing units and configured to store infrastructure parameters, threat characterization profiles, and adaptive threshold values; and a validation unit (106) configured to apply artificial intelligence based pattern recognition and characterization logic to confirm security configurations, wherein the system employs adaptive characterization thresholds based on infrastructure parameters and integrates artificial intelligence validation mechanisms to enhance infrastructure reliability and threat identification within operational environments.

In an embodiment, the processing units (102) comprise high-precision security processing components configured to perform continuous threat identification by evaluating attack properties, threat behavior patterns, and infrastructure state transitions stored within the memory unit.

In an embodiment, the processing units (102) are further configured to implement energy-efficient characterization operations by dynamically regulating computational activity in response to threat severity and infrastructure operational criticality.

In an embodiment, the validation unit (106) is configured to perform continuous characterization confirmation by correlating threat signatures with historical characterization data and adaptive learning parameters stored in the memory unit.

In an embodiment, the validation unit (106) performs multi-stage validation by applying graduated characterization requirements corresponding to predefined security assessment levels associated with different infrastructure components.

In an embodiment, the system further comprises a monitoring unit (108) configured to track threat patterns, characterization metrics, and identification accuracy over time to support optimized security determination against evolving cyber uncertainties.

In an embodiment, the monitoring unit (108) generates characterization performance data that is stored in the memory unit and used to refine adaptive thresholds and validation parameters.

In an embodiment, the system is configured to activate tiered validation responses based on detected threat type, attack history, and infrastructure-specific risk indicators stored within the memory unit.

In an embodiment, the tiered validation responses comprise selective escalation of characterization procedures, increased validation depth, and enhanced monitoring frequency for high-risk threat conditions.

In an embodiment, the system further comprises an integration unit configured to securely connect with infrastructure operational monitoring systems to exchange characterization logs, security alerts, and validated threat information.

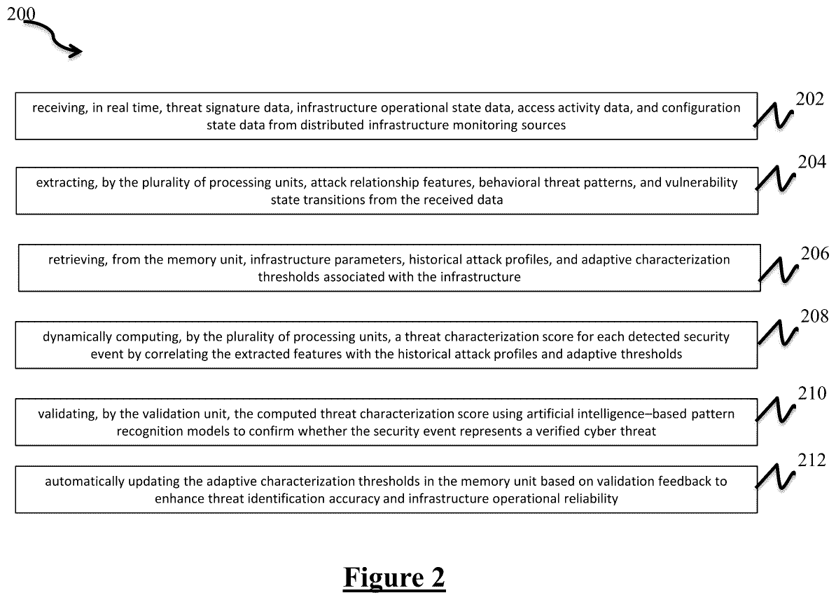

Referring to FIG. 2, a flow chart for a method for a computer-implemented method for autonomous agentic artificial intelligence-based defense of critical infrastructure, the method being executed by a compliance and security control computing platform comprising a plurality of processing units, a memory unit, and a validation unit, is illustrated. The method 200 comprises:
At step 202, the method 200 includes receiving, in real time, threat signature data, infrastructure operational state data, access activity data, and configuration state data from distributed infrastructure monitoring sources;
At step 204, the method 200 includes extracting, by the plurality of processing units, attack relationship features, behavioral threat patterns, and vulnerability state transitions from the received data;
At step 206, the method 200 includes retrieving, from the memory unit, infrastructure parameters, historical attack profiles, and adaptive characterization thresholds associated with the infrastructure;
At step 208, the method 200 includes dynamically computing, by the plurality of processing units, a threat characterization score for each detected security event by correlating the extracted features with the historical attack profiles and adaptive thresholds;
At step 210, the method 200 includes validating, by the validation unit, the computed threat characterization score using artificial intelligence-based pattern recognition models to confirm whether the security event represents a verified cyber threat; and
At step 212, the method 200 includes automatically updating the adaptive characterization thresholds in the memory unit based on validation feedback to enhance threat identification accuracy and infrastructure operational reliability.

In an embodiment, extracting the attack relationship features comprises modeling lateral movement paths, privilege escalation chains, and vulnerability propagation transitions between infrastructure assets, wherein dynamically computing the threat characterization score further comprises weighting the extracted features based on infrastructure criticality levels and real-time operational sensitivity.

Referring jointly to FIG. 1 and FIG. 2, the system 100 and method 200 are executed through a distributed agentic control architecture in which each hardware-software component performs a defined physical and computational role to realize autonomous infrastructure defense. The plurality of processing units (102) are implemented as parallel security computation engines comprising multi-core CPUs, AI accelerators, and real-time protocol processors that execute agent-specific inference pipelines for feature extraction, behavioral graph construction, state transition modeling, and threat scoring directly over live OT/ICS/SCADA telemetry streams. The memory unit (104) is a secure hybrid storage subsystem formed by high-speed volatile memory and encrypted non-volatile repositories that physically store infrastructure topology graphs, asset interdependency models, historical attack fingerprints, adaptive characterization thresholds, validation parameters, and agent coordination states, and that provides indexed, low-latency retrieval of time-aligned threat vectors required during real-time execution of the method. The validation unit (106) is a dedicated AI-based decision verification engine comprising ensemble classifiers, confidence-bound evaluators, and correlation processors that apply multi-stage pattern recognition, historical signature matching, and adaptive threshold validation to confirm whether computed threat scores satisfy graduated security assessment criteria associated with specific infrastructure components. The monitoring unit (108) is implemented as a continuous analytics and telemetry feedback processor that measures characterization accuracy, false alarm rates, drift in behavioral baselines, response latency, and threat evolution patterns, generates performance vectors, and persistently stores them in the memory unit to drive automated recalibration of

thresholds, retraining of agent models, and refinement of validation logic. The integration unit is a secure bidirectional communication gateway comprising protocol translators, encryption modules, and authentication handlers that physically interfaces with operational control systems, sensors, PLCs, HMIs, SIEM platforms, and asset management servers to exchange telemetry, configuration states, validated alerts, and characterization logs in real time. During execution of the method, the integration unit ingests operational data, the memory unit structures and contextualizes the data, the processing units generate dynamic threat representations, the validation unit confirms or escalates characterization using adaptive intelligence, and the monitoring unit continuously optimizes the entire decision pipeline, thereby forming a closed-loop, self-adaptive, multi-agent cyber-physical defense system that achieves machine-speed detection, reduced false positives, and resilient protection of safety-critical infrastructure under evolving attack conditions.

In one embodiment, the extraction of attack relationship features is implemented by continuously constructing a dynamic dependency graph of the protected infrastructure in which each computing node, industrial controller, network segment, identity credential, and software service is represented as an interconnected entity with stateful attributes. As real-time telemetry is received, the processing units trace access flows, authentication transitions, configuration changes, and service-to-service communications to infer possible lateral movement paths and privilege escalation chains. These paths are not treated as static sequences; instead, they are modeled as time-evolving propagation trajectories in which each hop is assigned a transition likelihood derived from historical breach records and current operational context. Vulnerability propagation

transitions are further identified by correlating detected configuration weaknesses, missing patches, or exposed interfaces with known exploit activation sequences stored in the system memory, thereby enabling the platform to predict how an initial compromise could spread across dependent assets.

The dynamically computed threat characterization score is then refined by applying infrastructure-aware weighting factors that reflect both asset criticality and real-time operational sensitivity. For example, if a lateral movement trajectory is detected moving toward a safety-critical industrial controller or a core grid management server during peak operational load, the corresponding feature weights are automatically amplified, whereas identical behavior directed toward a non-critical logging server is down-weighted. Operational sensitivity is continuously derived from live system metrics such as load levels, fault tolerance margins, redundancy availability, and service-level thresholds, allowing the same behavioral pattern to yield different risk values depending on current system conditions. The technical effect achieved is a context-adaptive threat assessment mechanism that prioritizes risks based on actual infrastructure impact rather than generic anomaly severity, thereby enabling faster, more accurate defensive responses and significantly improving the resilience and operational continuity of the protected critical infrastructure.

In an embodiment, comprising dynamically regulating, by the plurality of processing units, computational workload, inference frequency, and model execution depth in response to detected threat severity and infrastructure operational criticality to achieve energy-efficient characterization, and wherein validating the computed threat characterization score comprises correlating the real-time threat signatures with historical characterization data and adaptive learning parameters stored in the memory unit, and wherein validating further comprises performing multi-stage characterization confirmation by applying graduated validation criteria corresponding to predefined security assessment levels for different infrastructure components. In one embodiment, the plurality of processing units implement an adaptive execution controller that continuously monitors both the computed threat severity values and the real-time operational criticality of the infrastructure assets involved, and uses these two factors to dynamically regulate how much computational effort is expended for threat characterization. When the detected activity corresponds to low-risk or non-critical subsystems, the controller reduces model execution depth, lowers inference frequency, and assigns lightweight statistical or rule-based evaluators to conserve processing power and energy. Conversely, when the threat severity exceeds predefined escalation thresholds or when the affected assets are classified as mission-critical, the controller automatically increases inference frequency, activates deeper multi-layer behavioral models, and allocates additional processing threads to perform fine-grained temporal and relational analysis. This dynamic modulation allows the system to scale computational intensity in real time, ensuring that high-risk events receive maximal analytical scrutiny while maintaining energy-efficient operation across large infrastructure environments.

The validation process is executed as a correlation-driven learning workflow in which real-time threat signatures are continuously matched against historical characterization records and adaptive learning parameters stored in the memory unit. Each newly generated threat score is compared to patterns of previously confirmed attacks, false positives, and benign anomalies to determine its statistical and behavioral similarity to known outcomes. This correlation step produces an initial confidence value that reflects both historical precedent and current behavioral alignment. The validation unit then performs multi-stage characterization confirmation by applying progressively stricter verification criteria aligned with predefined security assessment levels associated with different infrastructure components. For example, events affecting safety-critical control systems are subjected to additional temporal sequence validation, propagation analysis, and behavioral divergence checks, whereas events impacting non-critical monitoring systems may pass through fewer stages. The technical effect achieved is a resource-aware, risk-sensitive validation architecture that improves detection accuracy, reduces false alarms, and ensures that computational resources are concentrated where they yield the greatest security and operational benefit.

In an embodiment, comprising tracking, by a monitoring unit, threat patterns, characterization metrics, validation confidence values, and identification accuracy over time; generating characterization performance data and storing the data in the memory unit for refining the adaptive thresholds and validation parameters; and activating tiered validation responses based on detected threat type, historical attack behavior, and infrastructure-specific risk indicators stored in the memory unit, and wherein activating the tiered validation responses comprises selectively escalating characterization procedures, increasing validation depth, and enhancing monitoring frequency for high-risk threat conditions.

In one embodiment, the monitoring unit operates as a continuous performance intelligence layer that observes not only the detected security events, but also the internal behavior of the threat characterization system itself over time. As each event is processed, the monitoring unit records the evolving threat patterns, the intermediate and final characterization scores, the validation confidence values assigned by the validation unit, and the subsequent correctness of the identification outcome as verified by system response behavior or post-incident analysis. These time-series performance metrics are aggregated into characterization performance profiles and stored in the memory unit as adaptive learning datasets. The processing units periodically analyze these profiles to detect systematic bias, drift in model behavior, or recurring misclassification patterns for specific asset categories or threat types, and automatically refine the adaptive thresholds and validation parameters to compensate for such deviations.

When a new security event is detected, the system references the stored historical performance data together with infrastructure-specific risk indicators, such as asset mission priority, exposure level, redundancy constraints, and known attack prevalence, to determine an appropriate validation tier. For low-risk or historically benign patterns, the system executes a baseline validation workflow with minimal computational overhead. For threat types that have previously resulted in confirmed compromises, rapid propagation, or operational disruption, the system activates higher validation tiers by selectively escalating the characterization procedures, increasing feature inspection depth, enabling additional correlation stages, and raising the monitoring frequency for the affected infrastructure segments. This tiered response mechanism ensures that the analytical rigor applied to each event is proportional to its operational risk, thereby achieving the technical effect of faster detection of high-impact threats, reduced false positives in low-risk scenarios, and continuously improving system accuracy through closed-loop performance feedback.

In an embodiment, receiving the threat signature data, infrastructure operational state data, access activity data, and configuration state data further comprises executing, by the plurality of processing units, a synchronized multi-channel ingestion pipeline in which network telemetry, endpoint execution traces, supervisory control system measurements, authentication event logs, and configuration baseline snapshots are temporally aligned using event-time watermarking, buffered within a sliding correlation window, normalized into a unified data schema, and converted into time-indexed security state vectors prior to feature extraction.

In one embodiment, the plurality of processing units implement a synchronized multi-channel ingestion pipeline that operates as a real-time data fusion layer for the protected infrastructure. Each incoming stream—network telemetry, endpoint execution traces, supervisory control and data acquisition (SCADA) measurements, authentication event logs, and configuration baseline snapshots—is first assigned an event-time stamp at the source and then revalidated upon arrival at the platform. An event-time watermarking mechanism is applied to determine the completeness boundary of each stream, allowing the system to distinguish late or out-of-order records from timely ones. The incoming records are then temporarily buffered within a sliding correlation window that spans a dynamically adjustable time horizon, so that logically related events originating from different sources can be aligned even when transmission delays or network jitter occur.

Once temporally aligned, the heterogeneous data elements are normalized into a unified security data schema by converting protocol-specific fields, device-dependent metrics, and vendor-specific log formats into standardized feature attributes. This normalization step produces a consistent representation of system behavior regardless of the originating source. The aligned and normalized records are then transformed into time-indexed security state vectors that encode the joint operational, access, and configuration context of the infrastructure at each moment. These vectors serve as the atomic analytical units for downstream feature extraction, enabling the system to correlate network anomalies with endpoint behavior, control system deviations, and configuration changes within the same temporal frame. The technical effect achieved is a coherent, time-synchronized representation of infrastructure activity that preserves causal relationships across disparate data channels, thereby significantly improving the accuracy, responsiveness, and reliability of subsequent attack relationship modeling and threat characterization.

In an embodiment, extracting the attack relationship features further comprises constructing, in the memory unit, a dynamically updated multi-layer infrastructure interaction graph in which logical identities, physical assets, software services, and communication interfaces are represented as distinct node layers, and in which directed edges encode privilege inheritance, data exchange paths, lateral movement permissions, configuration dependencies, and vulnerability exposure relationships, and wherein the plurality of processing units compute propagation weights for each edge using historical breach transition statistics and real-time operational load indicators.

In one embodiment, the system maintains within the memory unit a continuously evolving multi-layer infrastructure interaction graph that serves as the core relational model for attack relationship analysis. Each layer of the graph represents a different abstraction of the protected environment, such as logical identity entities, physical and virtual assets, application and service components, and network or control communication interfaces. Nodes across different layers are cross-linked through typed associations, allowing the system to capture how a compromised credential may grant access to a server, how that server may host a critical service, and how the service may interact with downstream control components. As real-time telemetry is ingested, the processing units update node states and edge attributes to reflect current access conditions, configuration dependencies, and observed communication behavior, thereby keeping the graph synchronized with the live operational environment.

Directed edges within the graph encode privilege inheritance paths, data exchange routes, lateral movement permissions, configuration coupling, and vulnerability exposure relationships. For each edge, the processing units calculate a propagation weight that represents the likelihood that a compromise will traverse that relationship. These weights are derived from a combination of historical breach transition statistics, such as how frequently a particular access path has been exploited in past incidents, and real-time operational load indicators, such as current service utilization, network congestion, and control system stress levels that may amplify exploitability. By dynamically recalculating these propagation weights, the system is able to simulate how an attack is most likely to spread across the infrastructure at any given moment. The technical effect achieved is a live, risk-aware relational model that enables accurate prediction of attack propagation paths, improves prioritization of defensive actions, and enhances the system's ability to contain threats before they impact critical operational components.

In an embodiment, dynamically computing the threat characterization score further comprises executing a distributed feature correlation engine that calculates temporal co-occurrence probabilities between access anomalies, configuration deviations, and operational instability indicators, applies adaptive weighting coefficients retrieved from the memory unit based on asset criticality tiers and mission impact profiles, and aggregates the weighted probabilities into a composite multi-dimensional risk vector from which the threat characterization score is derived through non-linear score normalization and confidence scaling.

In one embodiment, the threat characterization score is generated by a distributed feature correlation engine that operates across multiple processing units in parallel to ensure real-time performance in large-scale critical infrastructure environments. As security state vectors and extracted features are streamed into the engine, the processing units compute temporal co-occurrence probabilities that quantify how often access anomalies, configuration deviations, and operational instability indicators occur together within the same correlated time window. Rather than treating these indicators as independent signals, the engine models their joint behavior over time, enabling it to distinguish isolated benign events from coordinated attack patterns that exhibit consistent cross-domain correlations.

For each correlated feature group, adaptive weighting coefficients are retrieved from the memory unit based on predefined asset criticality tiers and mission impact profiles. These coefficients reflect the operational importance of the affected components and the potential consequences of their compromise. For example, a configuration deviation on a safety controller in a power substation is weighted more heavily than the same deviation on a non-critical reporting node. The weighted co-occurrence probabilities are then aggregated into a composite multi-dimensional risk vector that represents distinct threat dimensions such as access misuse, configuration compromise, lateral propagation potential, and operational destabilization. This vector is transformed into a single threat characterization score using non-linear normalization functions that emphasize high-risk combinations while compressing low-risk noise, followed by confidence scaling based on historical validation accuracy. The technical effect achieved is a highly discriminative and context-aware scoring mechanism that reflects both behavioral coordination and infrastructure impact, thereby enabling faster, more precise identification of genuine cyber threats and reducing false alarms across complex operational environments.

In an embodiment, validating the computed threat characterization score further comprises performing a dual-path verification procedure in which a first validation path executes behavior sequence matching against historical attack trajectories stored in the memory unit while a second validation path performs anomaly divergence analysis against baseline infrastructure behavior models, and wherein the validation unit reconciles outputs from the two paths by computing a consensus confidence value using dynamically adjusted reconciliation thresholds.

In one embodiment, the validation unit implements a dual-path verification architecture that independently evaluates each computed threat characterization score through two complementary analytical processes. In the first validation path, the system performs behavior sequence matching by comparing the ordered sequence of extracted attack features—such as access transitions, privilege changes, configuration modifications, and lateral movement steps—against historical attack trajectories stored in the memory unit. These trajectories are represented as time-labeled behavioral chains derived from previously confirmed incidents, allowing the system to measure structural similarity, transition alignment, and temporal progression consistency between the current event and known attack patterns. A similarity score is generated that reflects how closely the observed behavior aligns with previously validated threats.

In parallel, the second validation path executes anomaly divergence analysis by evaluating the same feature sequence against baseline infrastructure behavior models that represent normal operational patterns for each asset class, service type, and network segment. This path calculates a divergence metric that quantifies how far the observed behavior deviates from statistically learned baselines under comparable operational conditions. The two validation outputs are then reconciled by the validation unit through a consensus engine that computes a unified confidence value. This reconciliation process applies dynamically adjusted thresholds that are continuously tuned based on historical false positive rates, detection latency, and asset criticality. When both paths indicate high risk, the confidence value is amplified; when their assessments diverge, the reconciliation thresholds determine whether additional validation stages are triggered. The technical effect achieved is a robust, bias-resistant validation mechanism that combines knowledge of past attack behaviors with real-time behavioral anomaly detection, significantly improving accuracy and reliability in identifying genuine cyber threats while minimizing false alarms.

In an embodiment, automatically updating the adaptive characterization thresholds further comprises applying a feedback-controlled learning loop in which validation confidence values, false positive indicators, and response latency metrics are continuously recorded, statistically analyzed, and used to recalibrate the adaptive thresholds through weighted parameter updates that are selectively applied to infrastructure zones exhibiting repeated threat misclassification.

In one embodiment, the system implements a feedback-controlled learning loop that continuously observes how well the threat characterization and validation processes perform after each detected security event. As events are processed, the validation unit records the assigned confidence values, whether the event was later confirmed as a true threat or a false positive, and the time taken by the system to generate a validated response. These measurements are stored as performance feedback records in the memory unit and are periodically aggregated into zone-specific performance profiles corresponding to different infrastructure segments, asset groups, or network domains.

The plurality of processing units statistically analyze these profiles to identify recurring misclassification patterns, such as consistently high false positives for a particular server cluster or delayed response for a specific industrial control zone. When such patterns are detected, the system computes weighted parameter adjustments that reflect both the severity and frequency of the observed errors. These adjustments are then applied selectively to the adaptive characterization thresholds associated with the affected infrastructure zones, rather than globally, ensuring that localized behavioral characteristics are accurately reflected. Over successive iterations, the thresholds converge toward values that better discriminate between benign anomalies and genuine attacks for each zone. The technical effect achieved is a self-correcting threat evaluation mechanism that continuously improves detection precision, reduces response delays, and adapts to evolving operational conditions without requiring manual reconfiguration.

In an embodiment, retrieving the infrastructure parameters further comprises loading topology dependency matrices, redundancy constraints, asset mission priority rankings, and operational tolerance limits from the memory unit, and wherein the plurality of processing units bind the retrieved parameters to the extracted features through indexed reference tables that enable context-aware correlation of threat behavior with infrastructure impact sensitivity.

In one embodiment, the memory unit maintains a structured repository of infrastructure context models that describe how the protected environment is physically and logically organized, how its components depend on one another, and what operational limits must be preserved to avoid service disruption. When the processing units retrieve infrastructure parameters, they load topology dependency matrices that encode upstream and downstream relationships between assets, redundancy constraints that define failover capabilities and allowable load redistribution, asset mission priority rankings that specify the criticality of each component to overall system operation, and operational tolerance limits that represent acceptable performance or safety thresholds for each subsystem.

These retrieved parameters are not treated as static metadata; instead, the processing units bind them to the extracted behavioral and relational features using indexed reference tables that map each feature to the corresponding asset identifiers, dependency chains, and mission impact attributes. Through this binding process, every detected anomaly, access transition, or configuration deviation is automatically contextualized with its potential infrastructure consequences. For example, a privilege escalation on a redundant backup server may be associated with low impact sensitivity, whereas the same escalation on a primary control node with no redundancy is mapped to a high-risk profile due to strict tolerance limits and mission priority. The technical effect achieved is a context-aware correlation mechanism that transforms raw threat behavior into infrastructure-relevant risk insight, enabling the system to prioritize responses based on real operational impact rather than generic security severity.

In an embodiment, validating the computed threat characterization score further comprises executing multi-stage validation cycles in which preliminary scores are subjected to progressively stricter verification criteria based on detected attack persistence, propagation velocity, and configuration impact depth, and wherein the validation unit adaptively increases model evaluation depth and feature inspection granularity when the preliminary score exceeds a dynamically computed escalation threshold.

In one embodiment, the validation unit executes the threat verification process as a sequence of adaptive, multi-stage validation cycles that become progressively more rigorous as the assessed risk increases. When a preliminary threat characterization score is generated, it is first evaluated using lightweight verification criteria that examine basic behavioral consistency and short-term anomaly persistence. If the activity exhibits sustained recurrence, rapid spread across assets, or configuration changes affecting multiple dependency layers, the system identifies this as increased attack persistence, propagation velocity, and configuration impact depth. These factors are continuously quantified and combined to compute a dynamic escalation threshold that reflects both current system conditions and historical attack behavior.

When the preliminary score exceeds this dynamically computed threshold, the validation unit automatically escalates to deeper validation stages by increasing model evaluation depth and expanding feature inspection granularity. At higher stages, the system performs longer temporal sequence analysis, cross-layer graph propagation checks, and fine-grained configuration correlation across dependent assets. Each stage applies stricter verification rules and higher confidence requirements before allowing the threat to be confirmed. This adaptive, stage-based validation architecture ensures that low-risk events are processed efficiently, while complex and high-impact threats receive comprehensive analytical scrutiny. The technical effect achieved is a scalable and risk-sensitive validation framework that improves detection accuracy, reduces unnecessary computational overhead, and enables early identification of persistent and fast-propagating cyber attacks in critical infrastructure environments.

In an embodiment, dynamically computing the threat characterization score further comprises assigning temporal decay factors to historical attack features, recalculating relevance weights based on recency and behavioral similarity, and recalibrating the score in real time to emphasize emerging threat patterns while suppressing outdated attack signatures stored in the memory unit.

In one embodiment, the system enhances the adaptability of the threat characterization process by continuously recalibrating how historical attack information influences the current risk assessment. Each stored attack feature and behavioral pattern in the memory unit is associated with a temporal decay factor that represents how its relevance diminishes over time. As the threat landscape evolves, older attack signatures are progressively down-weighted unless they continue to exhibit behavioral similarity with newly observed events. The plurality of processing units periodically update these decay factors by measuring the time elapsed since each pattern was last observed and by comparing its structural and temporal characteristics with current activity streams.

When a new security event is analyzed, the system recalculates relevance weights by jointly considering both the recency of historical features and their behavioral similarity to the present feature set. Patterns that are recent and closely aligned with the observed behavior are amplified, while those that are outdated or weakly correlated are attenuated. The dynamically adjusted weights are then applied during score aggregation, allowing the threat characterization score to shift emphasis toward emerging or actively exploited techniques. This real-time recalibration prevents legacy attack models from dominating the scoring process and ensures that the system remains responsive to novel threat behaviors. The technical effect achieved is a continuously self-updating threat evaluation mechanism that reflects current adversary tactics, improves detection of zero-day or rapidly evolving attacks, and reduces misclassification caused by obsolete historical data.

In an embodiment, receiving the data from distributed infrastructure monitoring sources further comprises cryptographically verifying data origin, enforcing integrity validation through chained hash verification, and rejecting telemetry packets that fail authentication or timestamp coherence checks prior to feature extraction.

In one embodiment, the ingestion layer incorporates a cryptographic trust verification mechanism to ensure that only authentic and tamper-free telemetry is admitted into the threat analysis pipeline. Each distributed monitoring source, such as network sensors, endpoint agents, industrial controllers, and authentication servers, is provisioned with a unique cryptographic identity and a signing key. As telemetry packets are generated, they are digitally signed and time-stamped at the source. Upon receipt, the plurality of processing units verify the digital signature to confirm the origin of the data and to ensure that the packet has not been altered in transit.

In addition to signature verification, the system enforces integrity validation through chained hash verification, in which each telemetry record contains a hash reference to the previous record from the same source. This creates an immutable sequence that allows the platform to detect insertion, deletion, or reordering of events. The processing units also perform timestamp coherence checks by comparing event-time values against synchronized system clocks and accepted drift thresholds. Any packet that fails authentication, hash-chain continuity, or temporal coherence validation is immediately rejected and logged as a potential data integrity violation before reaching the feature extraction stage. The technical effect achieved is a trusted data ingestion framework that prevents adversarial data poisoning, spoofed telemetry injection, and replay attacks, thereby preserving the reliability and security of the autonomous threat characterization process.

In an embodiment, extracting the vulnerability state transitions further comprises monitoring configuration drift events, patch level changes, privilege reassignment events, and firmware version transitions, and correlating the detected transitions with known exploit activation sequences stored in the memory unit to dynamically adjust the extracted attack relationship features.

In one embodiment, the system continuously observes the evolving security posture of each infrastructure component by tracking configuration drift events, patch level changes, privilege reassignment actions, and firmware version transitions across servers, controllers, network devices, and embedded systems. These state changes are captured in real time and encoded as temporal transition events that reflect how an asset's vulnerability surface is expanding or contracting over time. Rather than treating such changes as isolated maintenance activities, the plurality of processing units correlate them with known exploit activation sequences stored in the memory unit, which describe the typical preconditions and configuration states required for specific attacks to succeed.

When a detected transition matches or partially aligns with a known exploit activation pattern, the system dynamically increases the risk relevance of the associated asset and adjusts the extracted attack relationship features to reflect the heightened probability of compromise propagation. For example, if a critical controller is downgraded to a firmware version known to expose a remote execution flaw, the system strengthens the lateral movement and privilege escalation weights for all dependent paths linked to that controller. Conversely, when patches or hardening changes remove exploit preconditions, the corresponding propagation likelihoods are reduced. The technical effect achieved is a continuously adaptive vulnerability-aware threat model that links configuration evolution directly to attack feasibility, enabling proactive risk assessment and more accurate prediction of how security weaknesses can be exploited within the infrastructure.

In an embodiment receiving the real-time data further comprises executing a fault-tolerant ingestion control layer that assigns sequence identifiers and event-time stamps to each telemetry record, performs out-of-order event reconciliation using vector clock synchronization, temporarily stores unmatched records in a reconciliation buffer, and releases the reconciled records to the plurality of processing units only after temporal consistency across data sources is achieved.

In one embodiment, the real-time data ingestion process is implemented through a fault-tolerant control layer that ensures temporal correctness and resilience against network delays, packet loss, and asynchronous reporting across distributed infrastructure sources. As telemetry records arrive, the control layer assigns each record a unique sequence identifier and validates or appends an event-time stamp that reflects the actual time of occurrence rather than the arrival time. To handle the inherent asynchrony between network sensors, endpoint agents, and industrial controllers, the system applies vector clock synchronization to track causal relationships between events originating from different sources.

When records arrive out of order or without a matching causal context, they are temporarily stored in a reconciliation buffer. The control layer continuously evaluates vector clock states to determine when sufficient related events have been received to establish temporal consistency across the correlated data streams. Only after this consistency is achieved are the reconciled records released to the plurality of processing units for feature extraction and threat analysis. This mechanism prevents misaligned or incomplete event sequences from distorting behavioral correlations. The technical effect achieved is a robust, fault-tolerant ingestion architecture that preserves causal ordering across heterogeneous data sources, thereby improving the accuracy and reliability of real-time attack detection in complex critical infrastructure environments.

In an embodiment, extracting the attack relationship features further comprises executing a rolling behavior graph construction process in which entities are represented as stateful nodes and security-relevant interactions are encoded as time-labeled edges, incrementally updating node risk states using weighted transition probabilities computed from both recent activity bursts and historical behavior distributions stored in the memory unit.

In one embodiment, the system implements a rolling behavior graph construction process that continuously models the evolving security relationships within the protected infrastructure. Each user identity, device, application, service, or control component is represented as a stateful node whose attributes reflect its current security posture, recent activity intensity, and historical behavior profile. As real-time telemetry is ingested, every security-relevant interaction—such as authentication attempts, command executions, data transfers, configuration modifications, or control signals—is encoded as a time-labeled edge connecting the corresponding nodes. These edges capture not only the existence of an interaction, but also its temporal context and directional flow, allowing the graph to evolve as a live representation of infrastructure behavior.

The processing units incrementally update the risk state of each node by applying weighted transition probabilities that are derived from a combination of short-term activity bursts and long-term historical behavior distributions stored in the memory unit. Recent abnormal spikes in interaction frequency or unusual access paths increase the transition weights, while stable, historically consistent behavior reduces them. As the graph rolls forward in time, older edges decay in influence and new edges are incorporated, enabling the system to reflect both persistence and change in attacker behavior. The technical effect achieved is a continuously self-updating relational threat model that captures dynamic attack evolution, enhances early detection of coordinated multi-stage intrusions, and provides a predictive foundation for assessing how risk propagates across interconnected infrastructure components.

In an embodiment, dynamically computing the threat characterization score further comprises partitioning the extracted feature space into orthogonal risk subspaces corresponding to access misuse, configuration compromise, lateral propagation, and operational destabilization, computing a partial risk vector for each subspace through parallel inference pipelines, and fusing the partial risk vectors into a unified threat state tensor through adaptive cross-correlation and confidence normalization operations.

In one embodiment, the system improves analytical precision by decomposing the extracted feature space into multiple orthogonal risk subspaces that each represent a distinct dimension of cyber-physical threat behavior, including access misuse, configuration compromise, lateral propagation, and operational destabilization. The plurality of processing units route the corresponding subsets of features into dedicated parallel inference pipelines, each optimized to evaluate the behavioral patterns and anomaly characteristics specific to its assigned risk domain. For example, the access misuse pipeline focuses on credential anomalies, session irregularities, and privilege changes, while the configuration compromise pipeline analyzes drift events, patch regressions, and unauthorized parameter modifications.

Each pipeline computes a partial risk vector that captures the intensity and confidence of suspicious behavior within its domain. These partial vectors are then fused into a unified threat state tensor through adaptive cross-correlation operations that measure interdependencies between the risk domains, such as how configuration changes amplify lateral movement potential or how access misuse correlates with operational instability. Confidence normalization is applied to balance contributions from each subspace based on historical reliability and asset sensitivity. The resulting tensor is transformed into the final threat characterization score. The technical effect achieved is a multi-dimensional, correlation-aware threat assessment framework that preserves domain-specific sensitivity while enabling holistic risk evaluation, thereby significantly enhancing detection accuracy and reducing false positives in complex infrastructure environments.

In an embodiment, validating the computed threat characterization score further comprises executing a validation arbitration engine that continuously compares model-predicted threat classes against observed post-event system responses, calculates misclassification gradients, and selectively retrains decision boundary parameters in the validation unit by applying constrained gradient updates to reduce recurring classification drift for specific infrastructure segments.

In one embodiment, the validation unit incorporates a validation arbitration engine that operates as a continuous self-correction mechanism for the threat classification models. After each validated security event, the engine observes the subsequent system response, such as access revocations, service degradations, process terminations, or operational recovery actions, and compares these real-world outcomes with the threat class predicted by the model. By analyzing whether the predicted severity and type of threat align with the actual impact and remediation behavior, the engine identifies instances of misclassification or overestimation and quantifies them as misclassification gradients.

These gradients represent the directional error between expected and observed outcomes and are accumulated for each infrastructure segment, asset category, and threat class. The processing units then apply constrained gradient updates to selectively adjust the decision boundary parameters of the validation models, ensuring that only the portions of the model associated with recurring drift are modified while preserving stable classification behavior elsewhere. Over time, this targeted retraining process reduces systematic bias and prevents model degradation caused by evolving operational conditions or attacker tactics. The technical effect achieved is a self-adaptive validation framework that continuously aligns predictive threat classification with real infrastructure behavior, thereby improving long-term accuracy, reducing false positives, and maintaining consistent security performance across heterogeneous critical infrastructure segments.

In an embodiment, automatically updating the adaptive characterization thresholds further comprises segmenting the memory unit into infrastructure-specific threshold zones, computing localized threshold adjustment factors based on zone-level threat density, response latency, and validation confidence dispersion, and propagating the adjusted thresholds to the plurality of processing units through a version-controlled parameter synchronization protocol.

In one embodiment, the memory unit is logically segmented into multiple infrastructure-specific threshold zones, each corresponding to a defined operational domain such as a network segment, control subsystem, geographic site, or asset cluster. For each zone, the system continuously aggregates zone-level performance indicators, including observed threat density, average response latency, and the statistical dispersion of validation confidence values. These indicators are analyzed to determine how effectively the current thresholds distinguish between benign anomalies and genuine threats within that specific zone.

Based on this analysis, the plurality of processing units compute localized threshold adjustment factors that reflect both the frequency and severity of misclassifications as well as the timeliness of system responses. Zones experiencing high false positives or delayed reactions are assigned corrective scaling factors that either relax or tighten their adaptive thresholds accordingly. The updated threshold values are then propagated to all processing units using a version-controlled parameter synchronization protocol that maintains consistency across distributed nodes and enables rollback to previous threshold versions if instability is detected. The technical effect achieved is a fine-grained, zone-aware threshold management framework that ensures threat sensitivity is tailored to localized operational behavior, improves detection reliability, and maintains coherent system-wide enforcement of adaptive security policies.

In operation, each processing unit associated with the system continuously acquires real-time data streams originating from critical infrastructure components, including network communication data, control signal telemetry, device status information, and operational state indicators. The acquired data is normalized and temporally synchronized within the processing unit to establish a consistent analytical representation. Baseline operational behavior profiles, stored within the associated memory unit, are used as reference models against which incoming data is compared. The technique initially performs a deviation analysis by computing behavioral divergences between observed data and stored baseline patterns, thereby identifying candidate threat signatures indicative of abnormal or potentially malicious activity.

Upon identification of a candidate threat signature, the processing unit executes an artificial intelligence based pattern recognition routine that evaluates the structural and temporal characteristics of the detected deviation. This routine analyzes attack relationships and vulnerability transitions by correlating the detected signature with stored threat characterization profiles, historical incident patterns, and infrastructure dependency relationships. The technique assigns a preliminary characterization score that reflects the likelihood of the observed deviation corresponding to a genuine cyber threat rather than a legitimate operational variation. This score is dynamically adjusted using adaptive characterization thresholds derived from infrastructure-specific parameters stored in the memory unit.

Following preliminary characterization, the detected threat information is forwarded to the validation unit, which applies a multi-stage validation technique to confirm the authenticity of the threat. The validation technique evaluates temporal consistency by assessing whether the detected behavior persists across multiple observation windows and aligns with known attack progression sequences. Cross-correlation logic is applied to compare the detected signature with historical threat patterns and previously validated incidents. In parallel, infrastructure operational constraints are evaluated to determine whether the detected deviation falls within acceptable operational tolerances. Only when the combined validation conditions exceed predefined confidence thresholds does the technique confirm the threat as a validated security incident.

The technique further incorporates tiered validation logic, wherein the depth and complexity of validation increase proportionally with the assessed threat severity and infrastructure criticality. For low-risk deviations, lightweight validation routines are executed to minimize computational overhead. For high-risk or high-impact threats, extended validation routines are triggered, including expanded temporal analysis, dependency-based propagation assessment, and increased monitoring frequency. This adaptive validation approach ensures efficient resource utilization while maintaining high confidence in threat confirmation.

Once a threat is validated, the technique records comprehensive characterization data within the memory unit, including threat attributes, validation confidence indicators, infrastructure context information, and temporal markers. Simultaneously, the monitoring unit updates characterization metrics and identification accuracy statistics, which are used to evaluate long-term system performance. These metrics are continuously analyzed by the learning unit to refine adaptive thresholds, update validation parameters, and improve future threat discrimination accuracy.

The technique also supports integration with external infrastructure monitoring systems through a secure integration unit. Validated threat information and characterization logs are transmitted in real time to authorized operational systems, enabling coordinated situational awareness without disrupting existing workflows. Where required, notification logic generates real-time alerts for operators and administrators, ensuring transparency and traceability of automated security decisions.

A key aspect of the technique is its self-improving learning process. The learning unit periodically evaluates stored characterization records, comparing validation outcomes with post-incident observations and resolution results. Mischaracterized events are identified, and corrective adjustments are applied to pattern recognition parameters, threshold values, and validation logic. This continuous feedback-driven adaptation enables the system to evolve autonomously in response to emerging attack techniques and changing infrastructure behavior without manual reconfiguration.

The technique is further optimized for energy efficiency and operational resilience. Processing units dynamically regulate computational activity based on current threat levels and infrastructure states, ensuring that intensive analysis routines are activated only when necessary. This selective

activation reduces power consumption and supports sustained operation in resource-constrained infrastructure environments. Additionally, the distributed nature of the technique ensures that threat detection and validation can continue even if individual processing units become unavailable, thereby maintaining overall system robustness.

Through the coordinated execution of data acquisition, deviation analysis, artificial intelligence based characterization, multi-stage validation, adaptive learning, and secure integration processes, the disclosed technique provides a comprehensive and autonomous defense capability. The techniqueic design ensures accurate threat identification, validated response readiness, and continuous improvement while preserving the safety, reliability, and uninterrupted operation of critical infrastructure systems.

The autonomous agentic AI defense system is implemented as a machine comprising a plurality of distributed defense nodes physically or logically coupled to critical infrastructure components. Each defense node includes a processing unit configured to execute artificial intelligence techniques, a memory unit storing threat models and operational baselines, a data acquisition interface connected to infrastructure sensors and network taps, and a secure communication interface enabling encrypted data exchange with other defense nodes and a coordination controller.

The processing unit of each defense node is configured to perform real-time analysis of incoming telemetry using machine learning models trained to recognize normal operational patterns and anomalous behaviors. These models include neural network architectures, probabilistic inference mechanisms, and adaptive classification structures that evolve based on observed threat intelligence. The memory unit maintains dynamic threat fingerprints, attack progression graphs, and validation states, enabling persistent contextual reasoning across detection cycles.

A coordination controller, implemented as either a centralized supervisory processor or a federated orchestration layer, aggregates validated threat assessments from multiple defense nodes and determines coordinated response actions. The controller includes a decision processing unit configured to apply policy constraints, infrastructure impact assessments, and response prioritization logic before issuing mitigation commands. These commands may include network isolation, access revocation, control signal modulation, or alert propagation to human operators.

The machine further comprises an autonomous validation subsystem that performs multi-factor confirmation of detected threats. This subsystem evaluates consistency across time-series data, corroborates signals from independent agents, and applies infrastructure-specific operational constraints to ensure that detected anomalies correspond to genuine security incidents. The validation subsystem thereby ensures that response actions are justified, auditable, and aligned with infrastructure safety requirements.

An adaptive learning unit continuously updates detection and validation models based on feedback from resolved incidents, simulated attack scenarios, and changing infrastructure configurations. This learning unit enables the system to autonomously improve its accuracy, resilience, and coverage over time without manual reconfiguration. Energy-efficient computation units and workload scheduling mechanisms are employed to balance detection fidelity with resource consumption, ensuring sustained operation in critical environments.

During operation, the defense nodes continuously monitor infrastructure data streams and locally evaluate threat indicators using embedded AI models. Upon detecting a potential anomaly, a defense node generates a preliminary threat hypothesis and shares relevant metadata with neighboring nodes through the secure communication interface. Multiple agents collaboratively assess the hypothesis, exchanging confidence scores, contextual interpretations, and temporal correlations.

Once a consensus threshold is achieved, the autonomous validation subsystem confirms the threat and forwards a validated incident profile to the coordination controller. The controller determines an appropriate response strategy based on predefined safety policies and real-time infrastructure conditions. Response actions are executed autonomously while maintaining system stability, and detailed incident logs are generated for forensic analysis and compliance purposes.

The system continuously learns from each incident, refining its models and updating threat representations to enhance future detection and response performance.

The disclosed autonomous agentic AI defense system provides significant advantages over prior art by enabling decentralized intelligence, autonomous validation, adaptive learning, and infrastructure-aware response within a unified machine architecture. The system reduces response latency, minimizes false alarms, enhances resilience against advanced threats, and ensures continuous protection without disrupting critical operations.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A computer-implemented method for autonomous agentic artificial intelligence-based defense of critical infrastructure, the method being executed by a compliance and security control computing platform comprising a plurality of processing units, a memory unit, and a validation unit, the method comprising:
receiving, in real time, threat signature data, infrastructure operational state data, access activity data, and configuration state data from distributed infrastructure monitoring sources;
extracting, by the plurality of processing units, attack relationship features, behavioral threat patterns, and vulnerability state transitions from the received data;
retrieving, from the memory unit, infrastructure parameters, historical attack profiles, and adaptive characterization thresholds associated with the infrastructure;
dynamically computing, by the plurality of processing units, a threat characterization score for each detected security event by correlating the extracted features with the historical attack profiles and adaptive thresholds;
validating, by the validation unit, the computed threat characterization score using artificial intelligence-based pattern recognition models to confirm whether the security event represents a verified cyber threat; and
automatically updating the adaptive characterization thresholds in the memory unit based on validation feedback to enhance threat identification accuracy and infrastructure operational reliability.

2. The method of claim 1, wherein extracting the attack relationship features comprises modeling lateral movement paths, privilege escalation chains, and vulnerability propagation transitions between infrastructure assets, wherein dynamically computing the threat characterization score further comprises weighting the extracted features based on infrastructure criticality levels and real-time operational sensitivity.

3. The method of claim 1, further comprising dynamically regulating, by the plurality of processing units, computational workload, inference frequency, and model execution depth in response to detected threat severity and infrastructure operational criticality to achieve energy-efficient characterization, and wherein validating the computed threat characterization score comprises correlating the real-time threat signatures with historical characterization data and adaptive learning parameters stored in the memory unit, and wherein validating further comprises performing multi-stage characterization confirmation by applying graduated validation criteria corresponding to predefined security assessment levels for different infrastructure components.

4. The method of claim 1, further comprising tracking, by a monitoring unit, threat patterns, characterization metrics, validation confidence values, and identification accuracy over time; generating characterization performance data and storing the data in the memory unit for refining the adaptive thresholds and validation parameters; and activating tiered validation responses based on detected threat type, historical attack behavior, and infrastructure-specific risk indicators stored in the memory unit, and wherein activating the tiered validation responses comprises selectively escalating characterization procedures, increasing validation depth, and enhancing monitoring frequency for high-risk threat conditions.

5. The method of claim 1, wherein receiving the threat signature data, infrastructure operational state data, access activity data, and configuration state data further comprises executing, by the plurality of processing units, a synchronized multi-channel ingestion pipeline in which network telemetry, endpoint execution traces, supervisory control system measurements, authentication event logs, and configuration baseline snapshots are temporally aligned using event-time watermarking, buffered within a sliding correlation window, normalized into a unified data schema, and converted into time-indexed security state vectors prior to feature extraction.

6. The method of claim 1, wherein extracting the attack relationship features further comprises constructing, in the memory unit, a dynamically updated multi-layer infrastructure interaction graph in which logical identities, physical assets, software services, and communication interfaces are represented as distinct node layers, and in which directed edges encode privilege inheritance, data exchange paths, lateral movement permissions, configuration dependencies, and vulnerability exposure relationships, and wherein the plurality of processing units compute propagation weights for each edge using historical breach transition statistics and real-time operational load indicators.

7. The method of claim 1, wherein dynamically computing the threat characterization score further comprises executing a distributed feature correlation engine that calculates temporal co-occurrence probabilities between access anomalies, configuration deviations, and operational instability indicators, applies adaptive weighting coefficients retrieved from the memory unit based on asset criticality tiers and mission impact profiles, and aggregates the weighted probabilities into a composite multi-dimensional risk vector from which the threat characterization score is derived through non-linear score normalization and confidence scaling.

8. The method of claim 1, wherein validating the computed threat characterization score further comprises performing a dual-path verification procedure in which a first validation path executes behavior sequence matching against historical attack trajectories stored in the memory unit while a second validation path performs anomaly divergence analysis against baseline infrastructure behavior models, and wherein the validation unit reconciles outputs from the two paths by computing a consensus confidence value using dynamically adjusted reconciliation thresholds.

9. The method of claim 1, wherein automatically updating the adaptive characterization thresholds further comprises applying a feedback-controlled learning loop in which validation confidence values, false positive indicators, and response latency metrics are continuously recorded, statistically analyzed, and used to recalibrate the adaptive thresholds through weighted parameter updates that are selectively applied to infrastructure zones exhibiting repeated threat misclassification.

10. The method of claim 1, wherein retrieving the infrastructure parameters further comprises loading topology dependency matrices, redundancy constraints, asset mission priority rankings, and operational tolerance limits from the memory unit, and wherein the plurality of processing units bind the retrieved parameters to the extracted features through indexed reference tables that enable context-aware correlation of threat behavior with infrastructure impact sensitivity.

11. The method of claim 1, wherein validating the computed threat characterization score further comprises executing multi-stage validation cycles in which preliminary scores are subjected to progressively stricter verification criteria based on detected attack persistence, propagation velocity, and configuration impact depth, and wherein the validation unit adaptively increases model evaluation depth and feature inspection granularity when the preliminary score exceeds a dynamically computed escalation threshold.

12. The method of claim 1, wherein dynamically computing the threat characterization score further comprises assigning temporal decay factors to historical attack features, recalculating relevance weights based on recency and behavioral similarity, and recalibrating the score in real time to emphasize emerging threat patterns while suppressing outdated attack signatures stored in the memory unit; and wherein receiving the data from distributed infrastructure monitoring sources further comprises cryptographically verifying data origin, enforcing integrity validation through chained hash verification, and rejecting telemetry packets that fail authentication or timestamp coherence checks prior to feature extraction.

13. The method of claim 1, wherein extracting the vulnerability state transitions further comprises monitoring configuration drift events, patch level changes, privilege reassignment events, and firmware version transitions, and correlating the detected transitions with known exploit activation sequences stored in the memory unit to dynamically adjust the extracted attack relationship features.

14. The method of claim 1, wherein receiving the real-time data further comprises executing a fault-tolerant ingestion control layer that assigns sequence identifiers and event-time stamps to each telemetry record, performs out-of-order event reconciliation using vector clock synchronization, temporarily stores unmatched records in a reconciliation buffer, and releases the reconciled records to the plurality of processing units only after temporal consistency across data sources is achieved.

15. The method of claim 1, wherein extracting the attack relationship features further comprises executing a rolling behavior graph construction process in which entities are represented as stateful nodes and security-relevant interactions are encoded as time-labeled edges, incrementally updating node risk states using weighted transition probabilities computed from both recent activity bursts and historical behavior distributions stored in the memory unit.

16. The method of claim 1, wherein dynamically computing the threat characterization score further comprises partitioning the extracted feature space into orthogonal risk subspaces corresponding to access misuse, configuration compromise, lateral propagation, and operational destabilization, computing a partial risk vector for each subspace through parallel inference pipelines, and fusing the partial risk vectors into a unified threat state tensor through adaptive cross-correlation and confidence normalization operations; and wherein validating the computed threat characterization score further comprises executing a validation arbitration engine that continuously compares model-predicted threat classes against observed post-event system responses, calculates misclassification gradients, and selectively retrains decision boundary parameters in the validation unit by applying constrained gradient updates to reduce recurring classification drift for specific infrastructure segments.

17. The method of claim 1, wherein automatically updating the adaptive characterization thresholds further comprises segmenting the memory unit into infrastructure-specific threshold zones, computing localized threshold adjustment factors based on zone-level threat density, response latency, and validation confidence dispersion, and propagating the adjusted thresholds to the plurality of processing units through a version-controlled parameter synchronization protocol.
